(19) United States
(12) Patent Application Publication
(10) Pub. No.: US 2004/0100558 A1
(43) Pub. Date: May 27, 2004

(54) Remote optical imaging device for electronic monocular telescope or digital binocular camera

(76) Inventor: Chen-Yang Huang, Taichung (TW)

Correspondence Address: BRUCE H. TROXELL, Suite 1404, 5205 Leesburg Pike, Falls Church, VA, 22041, US

(21) Appl. No.: 10/319,552

(22) Filed: Dec. 16, 2002

(30) Foreign Application Priority Data
Nov. 22, 2002 (TW) 91218875

(51) Int. Cl. H04N 5/225

(52) U.S. Cl. 348/207.99

(57) ABSTRACT

A remote optical imaging device used in an electronic monocular telescope or digital binocular camera comprises a focusing lens, optical laser sensor and optical electric circuit module. The focusing lens is located behind an objective lens. The optical laser sensor is located behind the focusing lens. So the objective lens, the focusing lens and the optical laser sensor are on the same straight line. Thus, the magnified image can be projected and focused on the focusing lens. The image further passes through the focusing lens and is projected onto the optical laser sensor for electronic focusing. The optical laser sensor is installed on the optical electric circuit module, so captured images can be converted into digital image signal through the optical electric circuit module. Through connection with network devices available for communication with remote computers, images can be directly stored or monitored. Therefore, the objective for remote imaging is obtained.

### FIELD OF THE INVENTION

The present invention is related to a remote optical imaging device. Especially, it provides an application for the electronic monocular telescopes or the digital binocular cameras in the market that are allowed to add to lens set with enhanced optical focusing, electronic focusing and optical image transmission path. As a result, 2000-meter imaging is made possible with direct storage for the captured image or indirect storage through various network equipments to achieve the objective of remote imaging.

### BACKGROUND OF THE INVENTION

In general, the electronic monocular telescopes and the digital binocular cameras in the market have a fixed magnification rate, which allows image capture only within an effective viewing range and fails to satisfy the demand of remote imaging. Particularly, it operators disturb the mobile objects in a short distance during observation or shooting, the original intention for observation or shooting will be ruined.

In view of the shortcomings associated with current products and the demand of remote observation or picture taking by electronic monocular telescopes or digital binocular cameras, the inventor for the present invention developed an electronic monocular telescope or a digital binocular camera that is used as a remote optical imaging device. It is installed in the lens set for an electronic monocular telescope or a digital binocular camera to enhance optical focusing and electronic focusing and provide optical image transmission path. So remote imaging at a distance up to 2,000 meters is allowed with direct storage of captured image or monitoring and storage through various network equipments. In this way, the objective of remote image capture is realized.

### BRIEF DESCRIPTION OF THE DRAWINGS

FIG. 1 is an embodiment for an electronic monocular telescope that is used as a remote optical imaging device for the present invention.

FIG. 2 is an embodiment for a digital binocular camera that is used as a remote optical imaging device for the present invention.

### DETAILED DESCRIPTION OF THE INVENTION

The following gives detailed explanations about the technical approach and characteristics with description for figures for an embodiment for the present invention.

The remote imaging device for the present invention is mainly used in the lens set for an electronic monocular telescope or a digital binocular camera and comprises a focusing lens 1, an optical laser sensor 2 and an optical electric circuit module 3.

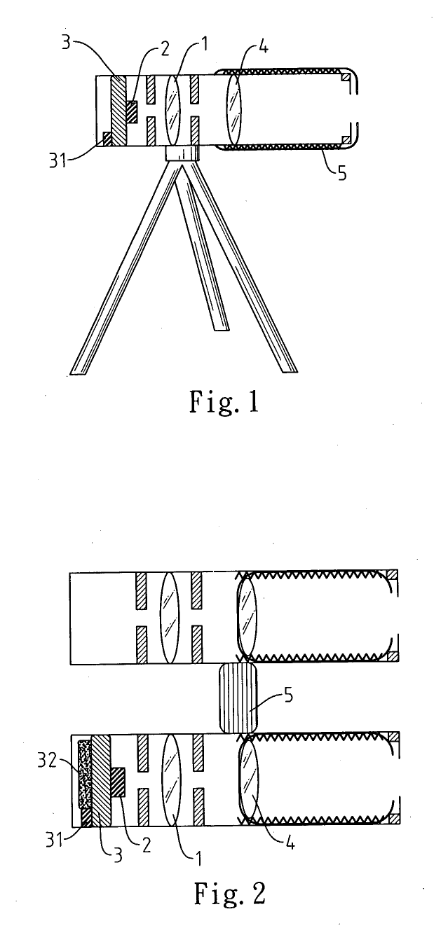

Please refer to FIG. 1. When the remote imaging device for the present invention is used in an electronic monocular telescope, the focusing lens 1 is located behind the objective lens 4 and the optical laser sensor 2 is located behind the focusing lens 1. Thus, the objective lens 4, the focusing lens 1 and the optical laser sensor 2 are on the same straight line. The magnified image by the objective lens 4 can be projected and optically focused on the focusing lens 1. The image further passes through the focusing lens 1 and is projected onto the optical laser sensor 2 for electronic focusing. The optical laser sensor 2 is installed on the optical electric circuit module 3, so the captured electronic image can be converted into a digital image signal through the optical electric circuit module 3. Further through connection ports 31 to various network equipments available for communication with remote commuters, the image can be directly stored or monitored by use of various network equipments. Besides, the electronic monocular telescope can adjust the position of the objective lens 4 through a rotary tube 5, so users are able to capture images of objects at different distances. The rotary tube 5 can be rotated manually or controlled by remote monitoring equipment.

Please refer to FIG. 2. When the remote imaging device for the present invention is used in a digital binocular camera, the focusing lens 1 is located behind the objective lens 4 and the optical laser sensor 2 is located behind the focusing lens 1. Thus, the objective lens 4, the focusing lens 1 and the optical laser sensor 2 are on the same straight line. The magnified image by the objective lens 4 can be projected and optically focused on the focusing lens 1. The image further passes through the focusing lens 1 and is projected onto the optical laser sensor 2 for electronic focusing. The optical laser sensor 2 is installed on the optical electric circuit module 3, so the captured electronic image can be converted into a digital image signal through the optical electric circuit module 3. The optical electric circuit module 3 has a battery set 32 to enable the direct storage of transformed image signal into the memory on the optical electric circuit module 3 or the direct transmission of image to the display of remote computers through connection ports 31 to various network equipments or further storage. In addition, the digital binocular camera can adjust the position of the objective lens 4 through a rotary tube 5, so users are able to capture images of objects at different distances. The rotary tube 5 can be rotated manually or controlled by remote monitoring equipment.

To sum up, the present invention is able to provide a remote imaging device that is installed in the lens set for an electronic monocular telescope or a digital binocular camera to enhance the optical focusing and electronic focusing and provide an optical image transmission path. As a result, 2000-meter imaging is made possible with direct storage for the captured image or indirect storage through various network equipments to achieve the objective of remote imaging.

What is claimed is:

1. A remote optical imaging device used in an electronic monocular telescope or a digital binocular camera, comprising a focusing lens, an optical laser sensor and an optical electric circuit module, characterized in that: said focusing lens is located behind an objective lens, said optical laser sensor is located behind said focusing lens, so said objective lens, focusing lens and optical laser sensor are all on a same straight line, thus, a magnified image by said objective lens can be projected and optically focused on said focusing lens, said image further passes through said focusing lens and is projected onto said optical laser sensor for electronic focusing, said optical laser sensor is installed on said optical electric circuit module, so captured electronic images can be converted into digital image signals through said optical electric circuit module, further through connection ports to various network devices available for communication with remote computers, said image can be directly stored or monitored by use of various network devices, therefore, an objective for remote imaging is obtained.

2. The remote optical imaging device used in an electronic monocular telescope or a digital binocular camera of claim 1, wherein said optical electric circuit module can further have a battery set as a power source for memory on said optical electric circuit module to directly store said transformed digital image signals.
